(19) United States
(12) Patent Application Publication
(10) Pub. No.: US 2023/0202802 A1
(43) Pub. Date: Jun. 29, 2023

(54) ELEVATOR CAR FRAME, ELEVATOR CAR AND ELEVATOR SYSTEM

(71) Applicant: Otis Elevator Company, Farmington, CT (US)

(72) Inventors: Yunzhu Shen, Shanghai (CN); Weifeng Peng, Shanghai (CN); Zhangli Gu, Shanghai (CN); Lan Wang, Shanghai (CN); Lili Zhao, Shanghai (CN)

(21) Appl. No.: 17/838,907

(22) Filed: Jun. 13, 2022

(30) Foreign Application Priority Data
Dec. 23, 2021 (CN) 202111586599.8

(51) Int. Cl. B66B 11/02; B66B 7/04; B66B 7/02

(52) U.S. Cl. CPC B66B 11/0206; B66B 7/047; B66B 7/021; B66B 9/00

(57) ABSTRACT

An elevator car frame, an elevator car and an elevator system. The elevator car frame includes a top, a bottom and uprights extending between the top and the bottom and deviating from a longitudinal middle portion of the elevator car frame, and at least one of the uprights is provided with car guide shoes arranged to enable the elevator car frame, after being installed in an elevator hoistway, to move along a car guide rail disposed in the elevator hoistway through the car guide shoes.

### FOREIGN PRIORITY

This application claims priority to Chinese Patent Application No. 202111586599.8, filed Dec. 23, 2021, and all the benefits accruing therefrom under 35 U.S.C. § 119, the contents of which in its entirety are herein incorporated by reference.

### TECHNICAL FIELD

The present disclosure relates to the technical field of elevators, and in particular to an elevator car frame, an elevator car and an elevator system.

### BACKGROUND

In modern life, various types of elevator devices have been widely used in many places such as high-rise buildings, public venues, and traffic stations. They can bring great convenience to people's daily work and travel, etc. In existing elevator systems, an elevator car and a cooperating counterweight are usually installed and arranged in an elevator hoistway, and at the same time, corresponding guide rails are installed on an inner wall of the elevator hoistway, so that the elevator car and the counterweight can move up and down along the respective guide rails, thereby transporting people and objects carried in the elevator car to a target floor.

FIG. 1 shows an installation method of an existing elevator car from a top view. The elevator car has a number of guide shoes arranged in a longitudinal middle position to cooperate with the corresponding guide rails in the elevator hoistway. Usually, four guide shoes are arranged on the elevator car. They are divided into two groups and are specifically installed on bottom and top cross beams on left and right sides of the elevator car. The two guide shoes in each group will be arranged as close to the center as possible in the longitudinal direction on the side of the elevator car so that they can be located on the same vertical line. This is because it has always been expected in the industry to achieve a balanced layout of the elevator car through such an arrangement, and it is believed that this is the optimal form of installation layout for the entire elevator system.

### SUMMARY

In view of the foregoing, the present disclosure provides an elevator car frame, an elevator car, and an elevator system, so as to solve or at least alleviate one or more of the above problems and other problems in the prior art.

Firstly, according to one aspect of the present disclosure, an elevator car frame is provided, which includes a top, a bottom, and uprights extending between the top and the bottom and deviating from a longitudinal middle portion of the elevator car frame, wherein at least one of the uprights is provided with car guide shoes arranged to enable the elevator car frame, after being installed in an elevator hoistway, to move along a car guide rail disposed in the elevator hoistway through the car guide shoes.

In the elevator car frame according to the present disclosure, optionally, the uprights include a first upright and a second upright that are arranged diagonally in the elevator car frame, and the car guide shoes include a first pair of car guide shoes and a second pair of car guide shoes, two car guide shoes of the first pair of car guide shoes are respectively arranged at an upper end and a lower end of the first upright, and two car guide shoes of the second pair of car guide shoes are respectively arranged at an upper end and a lower end of the second upright.

In the elevator car frame according to the present disclosure, optionally, the first upright is closer to a counterweight guide rail disposed in the elevator hoistway than the second upright, and the car guide shoes of the first pair of car guide shoes are arranged parallel to or perpendicular to counterweight guide shoes arranged on an elevator counterweight.

In the elevator car frame according to the present disclosure, optionally, the car guide shoes of the first pair of car guide shoes are arranged parallel to or perpendicular to the car guide shoes of the second pair of car guide shoes.

In the elevator car frame according to the present disclosure, optionally, the elevator car frame further includes car guide shoes arranged on a cross beam of the top and/or a cross beam of the bottom.

Further, according to another aspect of the present disclosure, an elevator car is also provided, which includes: the elevator car frame as described in any of the above items; and a panel attached to the elevator car frame and defining an inner space of the elevator car.

In addition, according to further another aspect of the present disclosure, an elevator system is further provided, which includes: an elevator hoistway provided to extend between multiple landings; the elevator car as described above, which is arranged in the elevator hoistway and provided to move between the multiple landings through the car guide shoes along the car guide rails in the elevator hoistway; and an elevator counterweight provided to move along counterweight guide rails in the elevator hoistway through counterweight guide shoes synchronously with the elevator car and in a direction opposite to the moving direction of the elevator car.

In the elevator system according to the present disclosure, optionally, the counterweight guide rails include a first counterweight guide rail and a second counterweight guide rail, the first counterweight guide rail is closer to the at least one upright than the second counterweight guide rail, and the first counterweight guide rail and the car guide rail are arranged on a same guide rail bracket in the elevator hoistway.

In the elevator system according to the present disclosure, optionally, the car guide rail and the first counterweight guide rail are connected to each other or integrally formed, and the part acting as the car guide rail are perpendicular to or parallel to the part acting as the first counterweight guide rail.

In the elevator system according to the present disclosure, optionally, the second counterweight guide rail is configured to have a different structural configuration from the first counterweight guide rail.

The present disclosure breaks through the traditional layout of the elevator car and proposes an innovative layout form, which can effectively optimize a space utilization rate of the elevator system in a building, realize an effect of reuse of the car guide rails and the counterweight guide rail, and promote cost reduction of the elevator system in terms of manufacture, installation and maintenance, making the present disclosure especially helpful in saving and releasing building space. The present disclosure not only has strong practicability and wide application range, but also has significant commercial application value.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structural configurations described herein, and are not required to be drawn to scale.

FIG. 1 is a schematic top structural view of an elevator car and a counterweight in the prior art when they are arranged in an elevator hoistway.

FIG. 2 is a schematic three-dimensional structural view of an embodiment of an elevator car frame according to the present disclosure.

FIG. 3 is a schematic top structural view when the embodiment of the elevator car frame and the example of the counterweight shown in FIG. 1 are arranged in the elevator hoistway.

FIG. 4 is another schematic top structural view when an embodiment of the elevator car frame and an example of the counterweight according to the present disclosure are arranged in the elevator hoistway.

FIG. 5 is a partially enlarged schematic view of the example of the guide rail shown in FIG. 4, in which a car guide shoe, a counterweight guide shoe and a guide rail bracket are shown at the same time.

FIG. 6 is further another schematic top structural view when an embodiment of the elevator car frame and an example of the counterweight according to the present disclosure are arranged in the elevator hoistway.

FIG. 7 is a partially enlarged schematic view of the example of the guide rail shown in FIG. 6, in which a car guide shoe, a counterweight guide shoe and a guide rail bracket are shown at the same time.

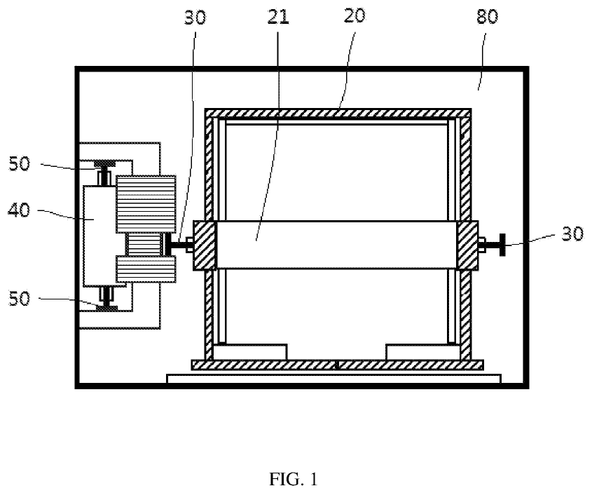

### DETAILED DESCRIPTION

First, it should be noted that the structure, components, characteristics, advantages and the like of the elevator car frame, the elevator car and the elevator system according to the present disclosure will be described below by way of example. However, neither of the descriptions should be understood as limiting the present disclosure in any way. In this document, technical terms “first” and “second” are only used for distinguishing purposes and are not intended to indicate their order and relative importance. The technical term “connect (or connected, etc.)” covers situations in which a component is directly and/or indirectly connected to another component.

In addition, for any single technical feature described or implied in the embodiments mentioned herein, or any single technical feature shown or implied in individual drawings, the present disclosure still allows for any combination or deletion of these technical features (or equivalents thereof) without any technical obstacle. Therefore, it should be considered that these more embodiments according to the present disclosure are also within the scope recorded in this document. In addition, for the sake of simplifying the drawings, identical or similar elements and features may be marked in only one or more places in the same drawing.

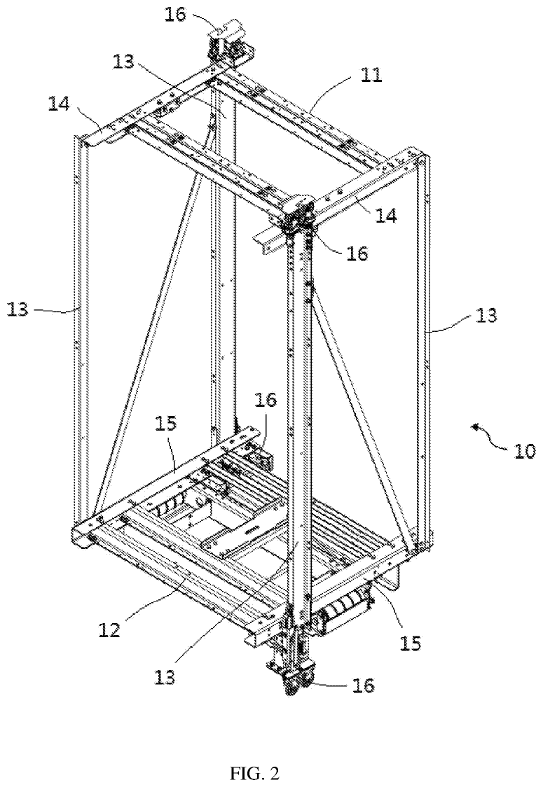

According to the design concept of the present disclosure, an elevator car frame for supporting an elevator car is first provided. FIG. 2 exemplarily shows a basic configuration of a specific embodiment of the elevator car frame, and some structures are simplified or omitted in the figure for the sake of clarity of the figure.

As shown in FIG. 2, the elevator car frame 10 may usually be made of a suitable rigid material such as steel and aluminum alloy, and includes a top 11, a bottom 12. Generally, cross beams are provided at these positions to enhance a strength of the frame. Cross beams 14 and cross beams 15 have been shown in FIG. 2. In addition, uprights 13 are provided between the top 11 and the bottom 12 for supporting. In practical applications, two, three or more uprights can be used, and they can be arranged such that for example ends thereof deviate from a longitudinal middle position of the frame. These uprights may be exactly the same in terms of material used, shape and size, etc., or they may be not exactly the same. The specific configuration may be set according to requirements.

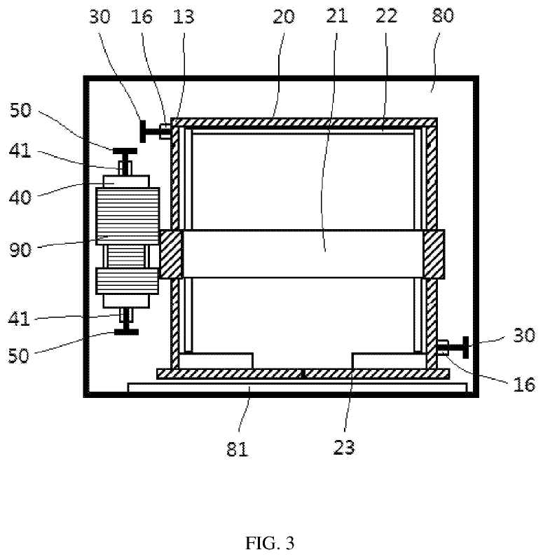

Car guide shoes 16 may be arranged on one or more uprights 13; for example, one car guide shoe 16 may be installed at upper and lower ends of the uprights respectively, so that after the elevator car frame 10 (or, an elevator car 20 formed further) is installed in place in an elevator hoistway 80, the car guide shoes 16 can be used to cooperate with corresponding car guide rails 30 installed in the elevator hoistway 80, thus enabling the elevator car frame 10 to move along the car guide rails 30. For example, as shown in FIGS. 2 and 3, one car guide shoe 16 may be arranged at their respective upper and lower ends of two uprights 13 respectively which are arranged diagonally in the elevator car frame 10, so as to form two groups of a total of four car guide shoes, which can effectively ensure that the elevator car frame 10 moves safely, smoothly and reliably in the elevator hoistway along the car guide rails 30.

When the elevator car frame 10 performs the above movement, an elevator counterweight 40 used for cooperation will move in the opposite direction along counterweight guide rails 50 in the elevator hoistway 80 through counterweight guide shoes 41. In FIG. 3, the parts associated with the above movements of the elevator car frame 10 and the counterweight guide rails 50, such as a traction machine, a sheave set, a speed governor, etc., are illustrated in a simplified manner, and a reference numeral 90 is used for them for general indication.

Substantively different from the traditional layout mentioned above, the present disclosure breaks through the inherent thinking held by the industry for a long time that the elevator car guide rails should be arranged in the center, and discards this deep-rooted traditional solution. According to the solution of the present disclosure, a guiding force for the operation of the elevator car is allowed to deviate from the longitudinal middle portion. By arranging the car guide shoes and guide rails on the uprights at other positions such as the ends, they can be prevented from contending for a limited space in the elevator hoistway with the counterweight in the elevator system. By arranging them at other positions deviating from the longitudinal middle position of the frame, a “mismatch” layout is formed, so as to promote their overall occupation space to be reduced and form a more compact system layout, which is not only advantageous for the elevator system, but also has considerable commercial value for buildings that have the characteristics of expensive construction cost, high usage area cost, and high sales price.

As an optional case, the car guide rails 30 and the adjacent counterweight guide rails 50 used by the elevator car frame 10 can be connected together for example by welding, or they can be integrally formed for example by casting and machining, so that a guide rail 60 that can be reused by both the car guide rails 30 and the counterweight guide rails 50 is formed; and then the guide rail 60 can be installed in the elevator hoistway 80 through a guide rail bracket 70. In this way, the elevator car frame 10 and the elevator counterweight 40 will move in opposite directions along the guide rail 60 through the car guide shoes 16 and the counterweight guide shoes 41 at their respective positions.

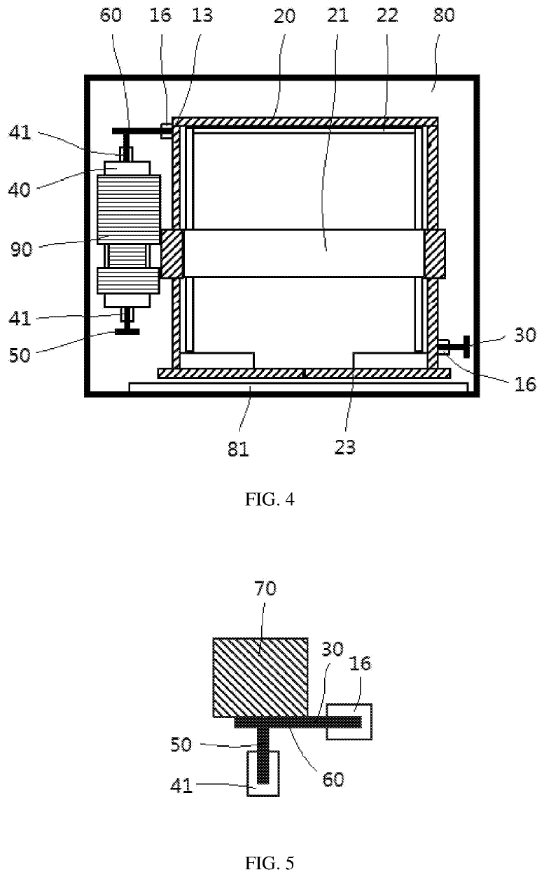

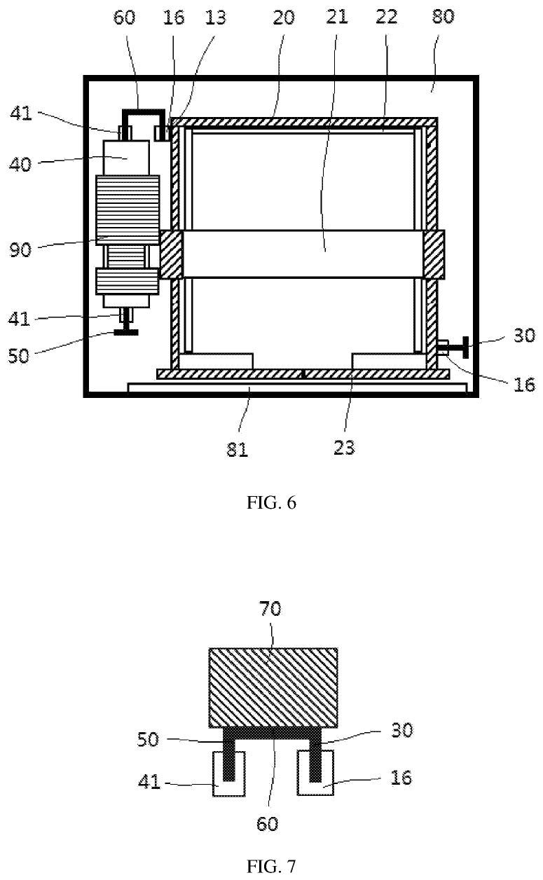

According to different applications, the guide rail 60 can be configured to have any feasible structure, thereby forming more spatial layout forms that can be selected. For example, FIGS. 4 and 5 show that the guide rail 60 can be made into a substantially irregular T-shape, that is, a configuration in which the car guide rail 30 and the counterweight guide rail 50 are perpendicular to each other is formed, so that a perpendicular arrangement is also formed between the matching car guide shoe 16 and counterweight guide shoe 41 positioned there. For another example, FIGS. 6 and 7 show that the guide rail 60 can be made into a substantially rectangular shape with a bottom side removed, that is, a configuration in which the car guide rail 30 and the counterweight guide rail 50 are parallel to each other is formed, so that a parallel arrangement is formed between the matching car guide shoe 16 and counterweight guide shoe 41 positioned there. In addition, at other positions in the elevator hoistway 80, the other car guide rails 30 on the elevator car frame 10 can still match with conventional guide rails with a T-shaped structure for example, so as to guide a running trajectory of the elevator car frame 10 together with the new guide rail 60, etc.

By adopting the above reuse design scheme of guide rails, the space utilization rate of the existing elevator guide rails can be further improved, thus saving and releasing the valuable space of buildings, and promoting the reduction of cost of the elevator system in terms of manufacture, installation and maintenance, etc. After a lot of research, the inventor found that in countries or regions that are faced with frequent natural disasters such as earthquakes and typhoons, for elevator guide rail materials and anti-destructive capabilities, etc., there are more safety considerations, and strong and compact buildings tend to be more popular. Therefore, by adopting the solution of the present disclosure, changing the original multiple rails to be the compact reused rail as discussed above will be welcomed, and the system installation operation is convenient and has high effect. Therefore, the present disclosure has significant practicability and application value.

It should be pointed out that as an optional situation, in some embodiments, in addition to the above innovative proposal of directly arranging the car guide shoes 16 on one or more uprights 13, it is also allowed to consider arranging one or more car guide shoes 16 on the cross beam 14 of the top 11 and/or the cross beam 15 of the bottom 12 at the same time as required. It should be understood that the car guide shoes 16 located on the elevator car frame 10 may be optionally arranged in parallel or perpendicular to each other.

According to the design concept of the present disclosure, on the basis of the elevator car frame, an elevator car and an elevator system can be further provided, so as to make full use of the outstanding technical advantages of the present disclosure over the existing technical solutions as described above.

Specifically, the elevator car frame designed and provided according to the present disclosure can be used to construct and support the elevator car, and a corresponding panel can be attached to the elevator car frame, thereby defining an inner space of the elevator car. For example, in FIG. 4 and other figures, an elevator car 20 constructed based on the above elevator car frame 10 is schematically shown. As an example, any possible components such as a car crosshead 21, an internal handrail 22 of the car, and a car door 23 can be equipped in the elevator car 20, and a landing door 81 is also shown in the figure. The elevator car and the counterweight can be arranged together in the elevator hoistway 80, and the elevator car 20 can be controlled to move between multiple landings in the elevator hoistway 80 through the car guide shoes 16 along the car guide rails 30, thereby carrying passengers, objects and the like to a target position.

It should be noted that the counterweight guide rails 50 in the elevator system according to the present disclosure can be installed at suitable positions in the elevator hoistway 80, and they may include counterweight guide rails with different structural configurations. This is exemplarily displayed in FIGS. 4 and 6. For example, one kind of the counterweight guide rails 50 may be used for reuse design with the car guide rail 30, and another kind can use any other suitable guide rail design such as a conventional T-shaped guide rail. The present disclosure does not impose any restrictions on this.

The elevator car frame, the elevator car and the elevator system according to the present disclosure have been elaborated above in detail by way of example only. These examples are merely used to illustrate the principles and embodiments of the present disclosure, rather than limiting the present disclosure. Various modifications and improvements can be made by those skilled in the art without departing from the spirit and scope of the present disclosure. Therefore, all equivalent technical solutions should fall within the scope of the present disclosure and be defined by the claims of the present disclosure.

1. (canceled)

2. The elevator system according to claim 7, wherein the uprights comprise a first upright and a second upright that are arranged diagonally in the elevator car frame, and the car guide shoes comprise a first pair of car guide shoes and a second pair of car guide shoes, two car guide shoes of the first pair of car guide shoes are respectively arranged at an upper end and a lower end of the first upright, and two car guide shoes of the second pair of car guide shoes are respectively arranged at an upper end and a lower end of the second upright.

3. The elevator system frame according to claim 2, wherein the first upright is closer to a counterweight guide rail disposed in the elevator hoistway than the second upright, and the car guide shoes of the first pair of car guide shoes are arranged parallel to or perpendicular to counterweight guide shoes arranged on an elevator counterweight.

4. The elevator system according to claim 2, wherein the car guide shoes of the first pair of car guide shoes are arranged parallel to or perpendicular to the car guide shoes of the second pair of car guide shoes.

5. The elevator system frame according to claim 7, further comprising car guide shoes arranged on a cross beam of the top and/or a cross beam of the bottom.

6. (canceled)

7. An elevator system, comprising:
an elevator hoistway provided to extend between multiple landings;
an elevator car having an elevator car frame, comprising a top, a bottom, and uprights extending between the top and the bottom and deviating from a longitudinal middle portion of the elevator car frame, wherein at least one of the uprights is provided with car guide shoes arranged to enable the elevator car frame, after being installed in an elevator hoistway, to move along a car guide rail disposed in the elevator hoistway through the car guide shoes;
the elevator car according arranged in the elevator hoistway and provided to move between the multiple landings through the car guide shoes along the car guide rails in the elevator hoistway; and
an elevator counterweight provided to move along counterweight guide rails in the elevator hoistway through counterweight guide shoes synchronously with the elevator car and in a direction opposite to the moving direction of the elevator car;
wherein the counterweight guide rails comprise a first counterweight guide rail and a second counterweight guide rail, the first counterweight guide rail is closer to the at least one upright than the second counterweight guide rail, and the first counterweight guide rail and the car guide rail are arranged on a same guide rail bracket in the elevator hoistway;
wherein the car guide rail and the first counterweight guide rail are integrally formed, and the part acting as the car guide rail are perpendicular to or parallel to the part acting as the first counterweight guide rail.

8. (canceled)

9. (canceled)

10. The elevator system according to claim 7, wherein the second counterweight guide rail is configured to have a different structural configuration from the first counterweight guide rail.
